(19) United States
(12) Patent Application Publication
(10) Pub. No.: US 2025/0148574 A1
(43) Pub. Date: May 8, 2025

(54) METHOD AND APPARATUS FOR ENHANCING PET PARAMETER IMAGE, DEVICE, AND STORAGE MEDIUM

(71) Applicant: SHENZHEN INSTITUTES OF ADVANCED TECHNOLOGY, Shenzhen (CN)

(72) Inventors: Hongzhao CHEN, Shenzhen (CN); Tao SUN, Shenzhen (CN); Yaping WU, Shenzhen (CN); Zhenguo WANG, Shenzhen (CN); Meiyun WANG, Shenzhen (CN)

(73) Assignee: SHENZHEN INSTITUTES OF ADVANCED TECHNOLOGY, Shenzhen (CN)

(21) Appl. No.: 19/003,261

(22) Filed: Dec. 27, 2024

Related U.S. Application Data
(63) Continuation of application No. PCT/CN2022/138173, filed on Dec. 9, 2022.

(30) Foreign Application Priority Data
Sep. 9, 2022 (CN) 202211103152.5

(51) Int. Cl. G06T 5/60; G06T 5/50; G06T 5/70

(52) U.S. Cl. CPC G06T 5/60; G06T 5/50; G06T 5/70; G06T 2207/10104; G06T 2207/20084

(57) ABSTRACT

The present disclosure discloses a method and apparatus for enhancing a PET parameter image, a device, and a storage medium. The method includes: obtaining, based on a preset mapping list, an input image corresponding to an original PET parameter image determined based on a dynamic PET image set; and inputting the input image into an image enhancement model, adjusting a model parameter of the image enhancement model based on the original PET parameter image and an output predicted PET parameter image until a preset number of iterations is met, and using the predicted PET parameter image as a target PET parameter image corresponding to the original PET parameter image; wherein the input image is a noise image, a dynamic PET image corresponding to a preset acquisition time range in the dynamic PET image set or a dynamic SUV image corresponding to the dynamic PET image.

### CROSS-REFERENCE TO RELATED APPLICATIONS

The application claims priority to Chinese patent application No. 202211103152.5, filed on Sep. 9, 2022, the entire contents of which are incorporated herein by reference.

### TECHNICAL FIELD

The present disclosure relates to the technical field of medical image processing, in particular to a method and apparatus for enhancing a PET parameter image, a device, and a storage medium.

### BACKGROUND

Positron emission computed tomography (PET) imaging is a medical imaging technology that adopts a tracer to detect metabolic characteristics of an organ of a human body or animal body, and has characteristics of high sensitivity, good accuracy, and accurate localization. A dynamic PET imaging technology may provide an image of distribution of a tracer at continuous time points, revealing a change law of activity of the tracer over time. By applying a kinetic model to a dynamic PET image sequence, PET parameter images that can reflect functional parameters of tissues and organs, such as a K₁ parameter image, a k₂ parameter image, a k₃ parameter image, and a Kᵢ parameter image, may be further obtained.

Currently, in order to improve image qualities of the PET parameter images, two modes are mainly adopted: a filtering algorithm or a neural network model. Although the first mode can reduce noises in the PET parameter images, it also reduces a spatial resolution of the PET parameter images and damages image details of the PET parameter images. The second mode mostly requires the PET parameter images with high image qualities as training labels to train an image enhancement model, while the PET parameter images with the high image qualities require longer scanning time or higher tracer injection doses, which does not meet clinical image acquisition requirements and brings great difficulty in preparation of the training labels.

### SUMMARY

Embodiments of the present disclosure provide a method and apparatus for enhancing a PET parameter image, a device, and a storage medium to solve the problem that an existing neural network model method requires preparation of a high-quality PET parameter image, and the image quality of the PET parameter image is improved while preserving image details of the PET parameter image.

A method for enhancing a PET parameter image is provided according to an embodiment of the present disclosure and includes:
determining an original PET parameter image based on an obtained dynamic PET image set, and obtaining an input image corresponding to the original PET parameter image based on a preset mapping list;
inputting the input image into an image enhancement model to obtain an output predicted PET parameter image; and
adjusting a model parameter of the image enhancement model based on the original PET parameter image and the predicted PET parameter image until a preset number of iterations is met, and using the predicted PET parameter image as a target PET parameter image corresponding to the original PET parameter image;
wherein the input image is a noise image, a dynamic PET image corresponding to a preset acquisition time range in the dynamic PET image set or a dynamic SUV image corresponding to the dynamic PET image.

An apparatus for enhancing a PET parameter image is provided according to another embodiment of the present disclosure and includes:
an input image obtaining module, configured to determine an original PET parameter image based on an obtained dynamic PET image set, and obtain an input image corresponding to the original PET parameter image based on a preset mapping list;
a predicted PET parameter image determining module, configured to input the input image into an image enhancement model to obtain an output predicted PET parameter image; and
a target PET parameter image determining module, configured to adjust a model parameter of the image enhancement model based on the original PET parameter image and the predicted PET parameter image until a preset number of iterations is met, and use the predicted PET parameter image as a target PET parameter image corresponding to the original PET parameter image;
wherein the input image is a noise image, a dynamic PET image corresponding to a preset acquisition time range in the dynamic PET image set or a dynamic SUV image corresponding to the dynamic PET image.

An electronic device is provided according to another embodiment of the present disclosure and includes:
at least one processor; and
a memory in communication connection with the at least one processor; wherein
the memory stores a computer program capable of being executed by the at least one processor, and the computer program is executed by the at least one processor to cause the at least one processor to be capable of executing the method for enhancing the PET parameter image according to any embodiment of the present disclosure.

A computer readable storage medium is provided according to another embodiment of the present disclosure, the computer readable storage medium stores a computer instruction, and the computer instruction is, when executed, used to cause a processor to implement the method for enhancing the PET parameter image according to any embodiment of the present disclosure.

In the technical solution of the embodiments of the present disclosure, based on the preset mapping list, the input image corresponding to the original PET parameter image determined based on the dynamic PET image set is obtained, wherein the input image is the noise image, the dynamic PET image corresponding to the preset acquisition time range in the dynamic PET image set or the dynamic SUV image corresponding to the dynamic PET image, the input image is input into the image enhancement model to obtain the output predicted PET parameter image, the model parameter of the image enhancement model is adjusted based on the original PET parameter image and the predicted PET parameter image until the preset number of iterations is met, and the predicted PET parameter image is used as the target PET parameter image corresponding to the original PET parameter image, so that the problem that the existing neural network model method requires the preparation of the high-quality PET parameter image is solved, and the image quality of the PET parameter image is improved while preserving the image details of the PET parameter image.

It should be understood that the content described in this part is not intended to identify key or important features of the embodiments of the present disclosure, nor is it used to limit the scope of the present disclosure. Other features of the present disclosure will be easily understood by the following description.

### BRIEF DESCRIPTION OF DRAWINGS

In order to explain the technical solution in embodiments of the present disclosure more clearly, accompanying drawings that need to be used in descriptions of the embodiments will be briefly introduced below. Apparently, the accompanying drawings in the following descriptions are only some embodiments of the present disclosure, and for those of ordinary skill in the art, on the premise of no creative work, other accompanying drawings may further be obtained from these accompanying drawings.

FIG. 1 is a flowchart of a method for enhancing a PET parameter image provided by Embodiment 1 of the present disclosure.

FIG. 2 is a flowchart of a method for enhancing a PET parameter image provided by Embodiment 2 of the present disclosure.

FIG. 3 is a schematic diagram of a model architecture of an image enhancement model provided by Embodiment 2 of the present disclosure.

FIG. 4 is a flowchart of a specific instance of a method for enhancing a PET parameter image provided by Embodiment 2 of the present disclosure.

FIG. 5 is a schematic structural diagram of an apparatus for enhancing a PET parameter image provided by Embodiment 3 of the present disclosure.

FIG. 6 is a schematic structural diagram of an electronic device provided by Embodiment 4 of the present disclosure.

### DETAILED DESCRIPTION OF THE EMBODIMENTS

In order to enable those of skills in the art to better understand the solution of the present disclosure, the following will clearly and completely describe the technical solution in embodiments of the present disclosure in conjunction with the accompanying drawings in the embodiments of the present disclosure. Obviously, the described embodiments are only a part of the embodiments of the present disclosure, rather than all the embodiments. Based on the embodiments in the present disclosure, all other embodiments obtained by those of ordinary skills in the art without creative work shall fall within the protection scope of the present disclosure.

It is to be noted that, the terms “include” and “have” in the description and claims of the present disclosure and in the above accompanying drawings, as well as any variations thereof are intended to cover non-exclusive incorporations, e.g., a process, method, system, product, or device that incorporates a series of steps or units need not be limited to those steps or units clearly listed, but may include other steps or units that are not clearly listed or are inherent to this process, method, product, or device.

### Embodiment 1

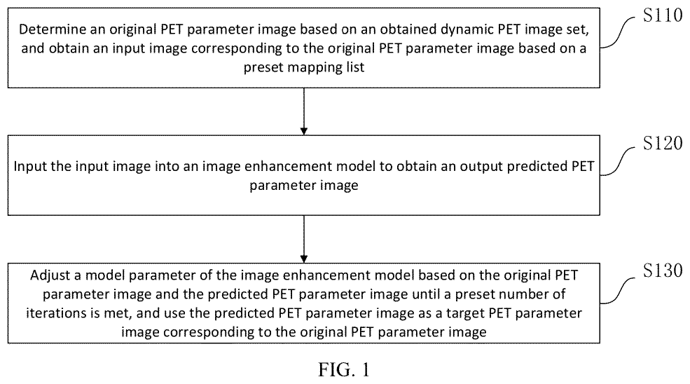

FIG. 1 is a flowchart of a method for enhancing a PET parameter image provided by Embodiment 1 of the present disclosure. The present embodiment is applicable to a case of performing image enhancement on a PET parameter image, the method may be executed by an apparatus for enhancing a PET parameter image, and the apparatus for enhancing the PET parameter image may be implemented in a form of hardware and/or software, and may be configured in a terminal device. As shown in FIG. 1, the method includes:

S110, an original PET parameter image is determined based on an obtained dynamic PET image set, and an input image corresponding to the original PET parameter image is obtained based on a preset mapping list.

Specifically, the dynamic PET image set contains at least two dynamic PET images. Exemplarily, an ¹⁸F-FDG PET/CT dynamic imaging scanning technology may be adopted to perform imaging scanning on a detected object to obtain the dynamic PET image set. A specific imaging technology adopted to obtain the dynamic PET image set is not limited here.

Exemplarily, the original PET parameter image may be a kinetic parameter image or a functional parameter image. For example, the kinetic parameter image may be a K₁ parameter image, a k₂ parameter image, a k₃ parameter image, and a k₄ parameter image, and the functional parameter image may be a Kᵢ parameter image. The Kᵢ parameter image may be used to reflect a rate of glucose uptake of a tissue and organ.

In an optional embodiment, specifically, when the original PET parameter image is the kinetic parameter image, kinetic modelling is performed on the dynamic PET image set through kinetic modelling to obtain the original PET parameter image. At this point, the image quality of the original PET parameter image obtained based on kinetic modelling is poor, which is not conducive to a subsequent image analysis.

Specifically, the preset mapping list may be used to characterize a mapping relationship between at least one original PET parameter image and at least one input image. Exemplarily, the preset mapping list contains at least one of the Kᵢ parameter image, the k₂ parameter image, the k₃ parameter image, the k₄ parameter image, or the Kᵢ parameter image, as well as input images that correspond to the original PET parameter images respectively. The input images that correspond to the original PET parameter images respectively may be the same or different.

In the present embodiment, the input image is a noise image, the dynamic PET image corresponding to a preset acquisition time range in the dynamic PET image set or a dynamic SUV image corresponding to the dynamic PET image.

Exemplarily, the noise image may be a salt-and-pepper noise image, a Gaussian noise image, or a mixed noise image, and a category of a noise contained in the noise image is not limited here.

Specifically, single acquisition of the dynamic PET image set requires a certain acquisition duration, typically 60 minutes. In the present embodiment, the preset acquisition time range is used to characterize a preset time period within a total acquisition duration corresponding to a dynamic acquisition image set. Taking an example that the total acquisition duration is 60 minutes, the preset acquisition time range may be 0-5 minutes, 10-15 minutes, or 50-60 minutes, etc.

In an optional embodiment, when the original PET parameter image is the K₁ parameter image, a minimum acquisition time corresponding to the preset acquisition time range is 0, or, a maximum acquisition time corresponding to the preset acquisition time range is the total acquisition duration corresponding to the dynamic PET image set.

In an embodiment, the minimum acquisition time corresponding to the preset acquisition time range is 0, the maximum acquisition time is less than a first time threshold, and the first time threshold is less than half of the total acquisition duration corresponding to the dynamic PET image set. Taking an example that the total acquisition duration is 60 minutes, the first time threshold is less than 30 minutes. In an optional embodiment, the preset acquisition time range is 0-5 minutes. In the present embodiment, he dynamic PET image corresponding to this preset acquisition time range is an early dynamic PET image in the dynamic PET image set.

In another embodiment, the minimum acquisition time corresponding to the preset acquisition time range is the total acquisition duration corresponding to the dynamic PET image set, the minimum acquisition time is greater than a second time threshold, and the second time threshold is greater than half of the total acquisition duration corresponding to the dynamic PET image set. Taking an example that the total acquisition duration is 60 minutes, the second time threshold is greater than 30 minutes. In an optional embodiment, the preset acquisition time range is 50-60 minutes. In the present embodiment, the dynamic PET image corresponding to this preset acquisition time range is a final dynamic PET image in the dynamic PET image set.

A study has demonstrated that the early dynamic PET image or the final dynamic PET image in the dynamic PET image set possesses a certain correlation with the K₁ parameter image. Therefore, the present embodiment may effectively improve the image quality of the K₁ parameter image by using the early dynamic PET image or the final dynamic PET image as an input image corresponding to the K₁ parameter image.

Specifically, a standard uptake value (SUV) image may characterize a ratio between an activity concentration of a tracer taken up by a tissue or organ and an average activity concentration of a whole body, which is used to reflect metabolic activity of glucose. Specifically, the dynamic PET image is multiplied by a weight of the detected object and divided by an injection dose of the tracer to obtain the dynamic SUV image.

An advantage of such setting is that individual differences between different detected objects may be weakened, and variable influences brought by a weight variable and an injection dose variable are eliminated by unifying the variables, which in turn improves the image quality of a subsequently obtained target PET parameter image.

S120, the input image is input into an image enhancement model to obtain an output predicted PET parameter image.

Specifically, the image enhancement model may perform image enhancement processing on the inputted input image to output the predicted PET parameter image. Exemplarily, a model architecture of the image enhancement model includes, but is not limited to, a generative adversarial network architecture, a U-NET architecture, super resolution convolutional neural networks (SRCNN), etc., and the model architecture of the image enhancement model is not limited here.

S130, a model parameter of the image enhancement model is adjusted based on the original PET parameter image and the predicted PET parameter image until a preset number of iterations is met, and the predicted PET parameter image is used as a target PET parameter image corresponding to the original PET parameter image.

In an optional embodiment, adjusting the model parameter of the image enhancement model based on the original PET parameter image and the predicted PET parameter image includes: determining a Euclidean distance difference between the original PET parameter image and the predicted PET parameter image based on an L2 loss function; and adjusting the model parameter of the image enhancement model by minimizing the Euclidean distance difference adopting an L-BFGS iterative algorithm.

Exemplarily, the model parameter meets a formula:

$${θ}^{*} = {arg min}_{θ} {‖x}_{0} - f ( θ \vert \hat{z} ) ‖ , {x}^{*} = f ( {θ}^{*} \vert \hat{z} )$$

where * represents an L2 norm operator, f represents the image enhancement model, \hat{z} represents the input image, x₀ represents the original PET parameter image, and x* represents a next predicted PET parameter image output by the image enhancement model based on an adjusted model parameter θ*.

An advantage of such setting is that the number of iterations of the image enhancement model may be reduced, and a memory space occupied by the image enhancement model may be reduced.

Specifically, in a case that a current number of iterations does not meet a preset number of iterations, predicted PET parameter images continue to be output based on the image enhancement model corresponding to the adjusted model parameter. Exemplarily, the preset number of iterations may be 1000 or 500, and is not limited here.

In the technical solution of the present embodiment, based on the preset mapping list, the input image corresponding to the original PET parameter image determined based on the dynamic PET image set is obtained, wherein the input image is the noise image, the dynamic PET image corresponding to the preset acquisition time range in the dynamic PET image set or the dynamic SUV image corresponding to the dynamic PET image, the input image is input into the image enhancement model to obtain the output predicted PET parameter image, the model parameter of the image enhancement model is adjusted based on the original PET parameter image and the predicted PET parameter image until the preset number of iterations is met, and the predicted PET parameter image is used as the target PET parameter image corresponding to the original PET parameter image, so that the problem that an existing neural network model method requires preparation of a high-quality PET parameter image is solved, and the image quality of the PET parameter image is improved while preserving image details of the PET parameter image.

### Embodiment 2

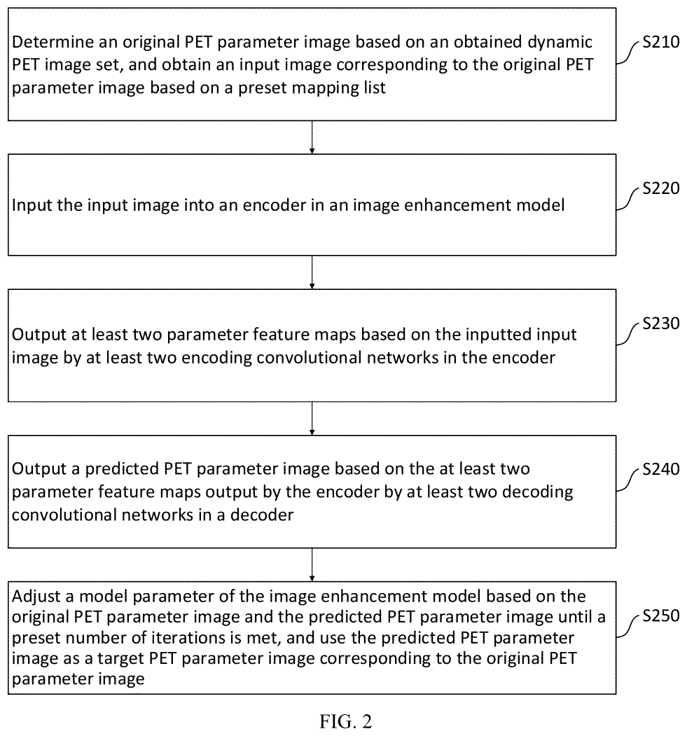

FIG. 2 is a flowchart of a method for enhancing a PET parameter image provided by Embodiment 2 of the present disclosure. The present embodiment further optimizes the image enhancement model in the above embodiment. As shown in FIG. 2, the method includes:

S210, an original PET parameter image is determined based on an obtained dynamic PET image set, and an input image corresponding to the original PET parameter image is obtained based on a preset mapping list.

S220, the input image is input into an encoder in the image enhancement model.

In the present embodiment, a model architecture of the image enhancement model is a U-NET architecture, wherein the U-NET architecture includes the encoder and a decoder.

Specifically, the encoder contains at least two encoding convolutional networks, the decoder contains at least two decoding convolutional networks, and the respective encoding convolutional networks and the respective decoding convolutional networks are symmetrically set. Encoding convolutional network and the decoding convolutional networks each contain a plurality of convolutional layers connected in series.

S230, at least two parameter feature maps are output based on the inputted input image by the at least two encoding convolutional networks in the encoder.

In an optional embodiment, a convolutional layer is set between every two adjacent encoding convolutional networks in the encoder. Exemplarily, a stride of at least one convolutional layer is 2. A convolutional parameter corresponding to each convolutional layer respectively is not limited here.

An advantage of such setting is that artifacts existing in the predicted PET parameter image output by the image enhancement model may be reduced.

Specifically, the first parameter feature map is determined based on the inputted input image by the first encoding convolutional network (i=1) in the encoder, and the first parameter feature map is output to the first convolutional layer as well as the last decoding convolutional network (j=n) in the decoder respectively. A first convolutional feature vector is determined based on the input first parameter feature map by the first convolutional layer in the encoder, and the first convolutional feature vector is output to the second encoding convolutional network. An i^{th} parameter feature map is determined based on an (i−1)th convolutional feature vector output by an (i−1)th convolutional layer by a current encoding convolutional network (1<i<n, n represents a total number of the encoding convolutional networks in the encoder) in the encoder, and the i^{th} parameter feature map is output to an i^{th} convolutional layer as well as to a decoding convolutional network in the decoder that corresponds to the current encoding convolutional network (j=n−i+1). By analogy, a last parameter feature map is determined based on an (n−1)th convolutional feature vector output by an (n−1)th convolutional layer by a last encoding convolutional network (i=n) in the encoder, and the last parameter feature map is output to the first decoding convolutional network (j=1) in the decoder.

S240, a predicted PET parameter image is output based on the at least two parameter feature maps output by the encoder by the at least two decoding convolutional networks in the decoder.

In an optional embodiment, a bilinear interpolation layer is set between every two adjacent decoding convolutional networks in the decoder.

An advantage of such setting is that artifacts existing in the predicted PET parameter image output by the image enhancement model may be reduced.

Specifically, by the first decoding convolutional network (j=1) in the decoder, a first upsampling feature map is determined based on the last parameter feature map output by the last encoding convolutional network in the encoder, and the first upsampling feature map is output to a first bilinear interpolation layer. A first interpolation feature vector is determined based on the first upsampling feature map by the first bilinear interpolation layer in the decoder, and the first interpolation feature map is output to the second decoding convolutional network. By a current decoding convolutional network (1<j<n) in the decoder, an i^{th} upsampling feature map is determined based on an (i−1)^{th} interpolation feature map output by an (i−1)^{th} bilinear interpolation layer as well as the parameter feature map input by the encoding convolutional network (i=n−j+1) in the encoder that corresponds to the current decoding convolutional network, and the i^{th} upsampling feature map is output to an i^{th} bilinear interpolation layer. By analogy, by a last decoding convolutional network (j=n) in the decoder, the predicted PET parameter image is determined based on an (n−1)^{th} interpolation feature map output by an (n−1)^{th} bilinear interpolation layer as well as the first parameter feature map input by the first encoding convolutional network in the encoder, and the predicted PET parameter image is output.

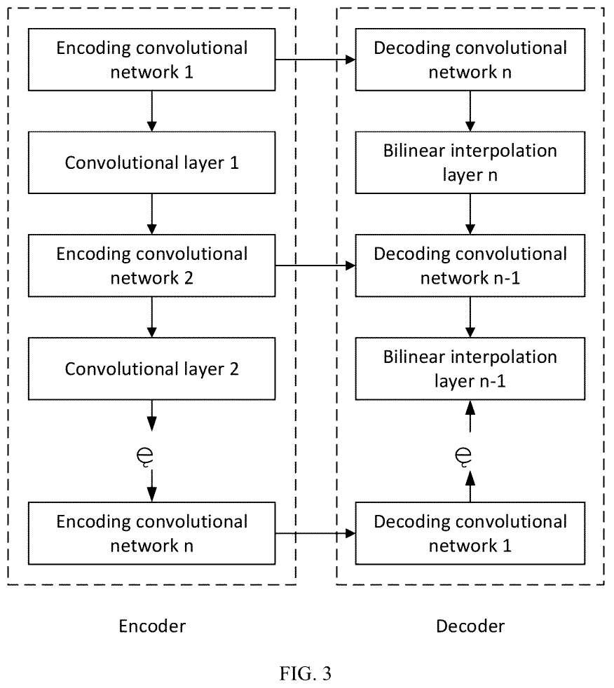

FIG. 3 is a schematic diagram of a model architecture of an image enhancement model provided by Embodiment 2 of the present disclosure. Specifically, the image enhancement model includes an encoder and a decoder, wherein the encoder contains n encoding convolutional networks, and a convolutional layer is set between every two adjacent encoding convolutional networks. The decoder contains n decoding convolutional networks, and a bilinear interpolation layer is set between every two adjacent decoding convolutional networks.

S250, a model parameter of the image enhancement model is adjusted based on the original PET parameter image and the predicted PET parameter image until a preset number of iterations is met, and the predicted PET parameter image is used as a target PET parameter image corresponding to the original PET parameter image.

Based on the above embodiment, optionally, before adjusting the model parameter of the image enhancement model based on the original PET parameter image and the predicted PET parameter image, the method further includes: normalizing the input image to obtain a normalized input image in a case that the input image is a dynamic PET image or a dynamic SUV image; and registering the normalized input image with the original PET parameter image to obtain a registered input image.

Specifically, the input image is used as a floating image, the original PET parameter image is used as a standard image, and a registration operation is performed on the input image and the original PET parameter image. Exemplarily, adopted registration algorithms include, but are not limited to, affine registration, rigid registration, etc.

An advantage of such setting is that computational efficiency of the image enhancement model may be improved, and the image quality of the target PET parameter image may be improved.

In an optional embodiment, before inputting the input image into the image enhancement model to obtain the output predicted PET parameter image, the method further includes: performing a cropping operation on the original PET parameter image and the input image respectively based on a preset cropping size to obtain a cropped original PET parameter image and a cropped input image.

Exemplarily, a region image corresponding to a region of interest may be only retained, e.g., the region of interest is an outlined rectangular box region of a brain, and an image size is 96*96*80. A cropped region and the cropping size are not limited here.

An advantage of such setting is that a subsequent computational amount of the image enhancement model may be reduced, and computational efficiency of the image enhancement model may be improved.

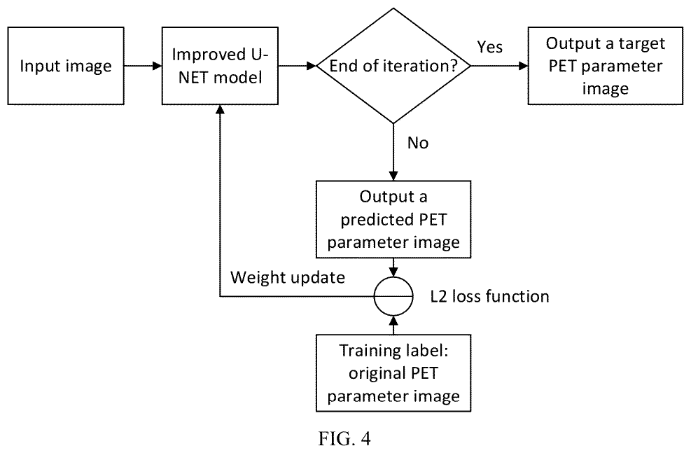

FIG. 4 is a flowchart of a specific instance of a method for enhancing a PET parameter image provided by Embodiment 2 of the present disclosure. Specifically, the input image is input into an improved U-NET model, and whether a current number of iterations meets a preset number of iterations is judged. If yes, it indicates that an iterative process is over, and a finally-output predicted PET parameter image is used as the target PET parameter image corresponding to the original PET parameter image. If no, the iterative process is not over, the original PET parameter image is used as a training label of the improved U-NET model, an L2 loss function is adopted to adjust a model weight of the image enhancement model based on the training label and a predicted PET parameter image output by the improved U-NET model to obtain an updated improved U-NET model corresponding to the current iterative process, and the iterative process continues.

Table 1 shows contrast-to-noise ratios (CNRs) and contrast-to-noise ratio improvement rates (CNRIRs) corresponding to different image enhancement methods provided by Embodiment 2 of the present disclosure respectively.

| Image enhancement | | |
|---|---|---|
| method | CNR(Mean ± SD) | CNRIR(Mean ± SD) |
| IM5-G | 22.53 ± 18.67 | 18.23% ± 9.12% |
| SUV-G | 19.86 ± 14.48 | 3.78% ± 9.88% |
| BM4D | 19.89 ± 17.03 | 3.83% ± 98.73% |
| DIP | 19.46 ± 18.53 | 2.01% ± 5.7% |
| GF | 19.07 ± 17.73 | 0.64% ± 15.68% |
| NLM | 20.39 ± 15.66 | 6.91% ± 14.34% |

where IM5-G represents that dynamic PET images within 0-5 minutes in the dynamic PET image set are used as input images, SUV-G represents that dynamic SUV images corresponding to dynamic PET images within 50-60 minutes in the dynamic PET image set are used as input images, BM4D represents a three-dimensional block-matched filtering method, DIP represents a deep image prior method, GF represents a Gaussian filter, and NLM represents a non-local mean method. The dynamic PET images are brain PET images that contain regions such as a vessel wall, gray matter, and white matter.

As can be obtained from Table 1, the contrast-to-noise ratios of the IM5-G method and SUV-G provided by the present embodiment are improved by 18.23% and 3.78% respectively compared to the original PET parameter image. The IM5-G method provides a substantial improvement in both contrast-to-noise ratio and contrast-to-noise ratio improvement rate compared to an existing image enhancement method.

In the technical solution of the present embodiment, the input image is input into the encoder in the image enhancement model, at least two parameter feature maps are output based on the inputted input image by at least two encoding convolutional networks in the encoder, the predicted PET parameter image is output based on the at least two parameter feature maps output by the encoder by at least two decoding convolutional networks in the decoder, the problem of the poor image quality of the target PET parameter image is solved, which makes it possible to obtain the target PET parameter image with a high contrast-to-noise ratio and rich image details utilizing the image enhancement model and the dynamic PET image set obtained from a single scanning process, and improves a convergence speed of the image enhancement model.

### Embodiment 3

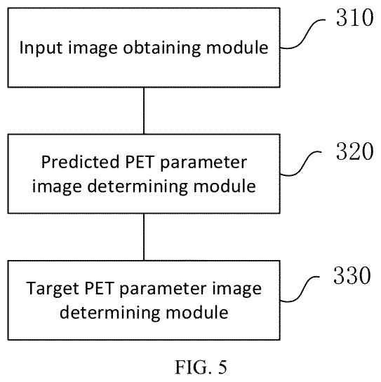

FIG. 5 is a schematic structural diagram of an apparatus for enhancing a PET parameter image provided by Embodiment 3 of the present disclosure. As shown in FIG. 5, the apparatus includes: an input image obtaining module 310, a predicted PET parameter image determining module 320, and a target PET parameter image determining module 330.

The input image obtaining module 310 is configured to determine an original PET parameter image based on an obtained dynamic PET image set, and obtain an input image corresponding to the original PET parameter image based on a preset mapping list.

The predicted PET parameter image determining module 320 is configured to input the input image into an image enhancement model to obtain an output predicted PET parameter image.

The target PET parameter image determining module 330 is configured to adjust a model parameter of the image enhancement model based on the original PET parameter image and the predicted PET parameter image until a preset number of iterations is met, and use the predicted PET parameter image as a target PET parameter image corresponding to the original PET parameter image.

The input image is a noise image, a dynamic PET image corresponding to a preset acquisition time range in the dynamic PET image set or a dynamic SUV image corresponding to the dynamic PET image.

In the technical solution of the present embodiment, based on the preset mapping list, the input image corresponding to the original PET parameter image determined based on the dynamic PET image set is obtained, wherein the input image is the noise image, the dynamic PET image corresponding to the preset acquisition time range in the dynamic PET image set or the dynamic SUV image corresponding to the dynamic PET image, the input image is input into the image enhancement model to obtain the output predicted PET parameter image, the model parameter of the image enhancement model is adjusted based on the original PET parameter image and the predicted PET parameter image until the preset number of iterations is met, and the predicted PET parameter image is used as the target PET parameter image corresponding to the original PET parameter image, so that the problem that an existing neural network model method requires preparation of a high-quality PET parameter image is solved, and the image quality of the PET parameter image is improved while preserving image details of the PET parameter image.

Based on the above embodiment, optionally, when the original PET parameter image is a K1 parameter image, a minimum acquisition time corresponding to the preset acquisition time range is 0, or, a maximum acquisition time corresponding to the preset acquisition time range is a total acquisition duration corresponding to the dynamic PET image set.

Based on the above embodiment, optionally, the apparatus further includes:
an input image registering module, configured to normalize, before adjusting the model parameter of the image enhancement model based on the original PET parameter image and the predicted PET parameter image, the input image to obtain a normalized input image in a case that the input image is the dynamic PET image or the dynamic SUV image; and
register the normalized input image with the original PET parameter image to obtain a registered input image.

Based on the above embodiment, optionally, a model architecture of the image enhancement model is a U-NET architecture, wherein the U-NET architecture includes an encoder and a decoder. Accordingly, the predicted PET parameter image determining module 320 is specifically configured to:
input the input image into the encoder in the image enhancement model;
output at least two parameter feature maps based on the inputted input image by at least two encoding convolutional networks in the encoder; and
output a predicted PET parameter image based on the at least two parameter feature maps output by the encoder by at least two decoding convolutional networks in the decoder.

Based on the above embodiment, optionally, a convolutional layer is set between every two adjacent encoding convolutional networks in the encoder.

Based on the above embodiment, optionally, a bilinear interpolation layer is set between every two adjacent decoding convolutional networks in the decoder.

Based on the above embodiment, optionally, the target PET parameter image determining module 330 is specifically configured to:
determine a Euclidean distance difference between the original PET parameter image and the predicted PET parameter image based on an L2 loss function; and
adjust the model parameter of the image enhancement model by minimizing the Euclidean distance difference adopting an L-BFGS iterative algorithm.

The apparatus for enhancing the PET parameter image provided by the embodiment of the present disclosure may execute the method for enhancing the PET parameter image provided by any embodiment of the present disclosure, and has functional modules and beneficial effects corresponding to the execution of the method.

### Embodiment 4

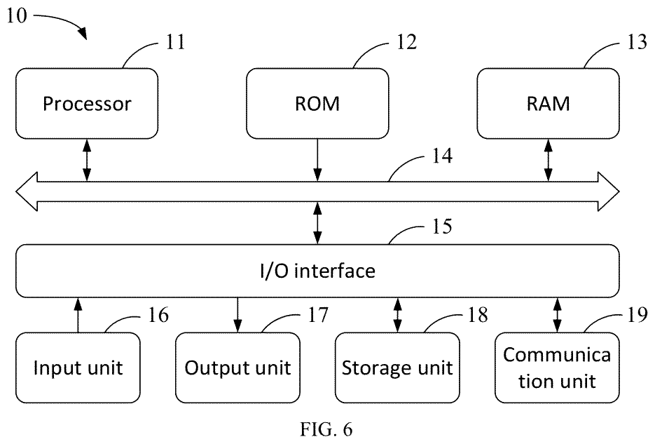

FIG. 6 is a schematic structural diagram of an electronic device provided by Embodiment 4 of the present disclosure. The electronic device 10 is intended to represent various forms of digital computers, such as, a laptop computer, a desktop computer, a workstation, a personal digital assistant, a server, a blade server, a mainframe computer, and other suitable computers. The electronic device may further represent various forms of mobile apparatuses, such as, personal digital processing, a cell phone, a smart phone, a wearable device (e.g., a helmet, eyeglasses, a watch, etc.) and other similar computing apparatuses. The components, their connections and relationships, and their functions shown in the embodiment of the present disclosure are merely used as examples, and are not intended to limit the implementations of the present disclosure described and/or required herein.

As shown in FIG. 6, the electronic device 10 includes at least one processor 11, and a memory, such as a read-only memory (ROM) 12 and a random access memory (RAM) 13, in communication connection with the at least one processor 11, wherein the memory stores a computer program executable by the at least one processor 11. The processor 11 may execute various appropriate actions and processing according to the computer program stored in the read-only memory (ROM) 12 or a computer program loaded from a storage unit 18 into the random access memory (RAM) 13. In the RAM 13, various programs and data required for operations of the electronic device 10 may further be stored. The processor 11, the ROM 12, and the RAM 13 are connected to each other through a bus 14. An input/output (I/O) interface 15 is also connected to the bus 14.

A plurality of components in the electronic device 10 are connected to the I/O interface 15, including: an input unit 16, such as a keyboard and a mouse; an output unit 17, such as various types of displays and speakers; a storage unit 18, such as a magnetic disk and an optical disk; and a communication unit 19, such as a network card, a modem and a wireless communication transceiver. The communication unit 19 allows the electronic device 10 to exchange information/data with other devices via a computer network, such as the Internet, and/or various telecommunication networks.

The processor 11 may be various general-purpose and/or special-purpose processing components with processing and computing capabilities. Some examples of the processor 11 include but are not limited to a central processing unit (CPU), a graphics processing unit (GPU), various dedicated artificial intelligence (AI) computing chips, various processors running machine learning model algorithms, a digital signal processor (DSP), and any appropriate processor, controller, microcontroller, etc. The processor 11 executes various methods and processing described above, such as the method for enhancing the PET parameter image.

In some embodiments, the method for enhancing the PET parameter image may be implemented as a computer program that is tangibly included in a computer readable storage medium such as the storage unit 18. In some embodiments, part or all of the computer programs may be loaded and/or installed onto the electronic device 10 via the ROM 12 and/or the communication unit 19. When the computer programs are loaded into the RAM 13 and executed by the processor 11, one or more steps of the method for enhancing the PET parameter image described above may be executed. Alternatively, in other embodiments, the processor 11 may be configured to execute the method for enhancing the PET parameter image in any other suitable manner (for example, by means of firmware).

Various implementations of the systems and technologies described above herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), computer hardware, firmware, software and/or their combinations. These various implementations may include: being implemented in one or more computer programs, wherein the one or more computer programs may be executed and/or interpreted on a programmable system including at least one programmable processor, and the programmable processor may be a special-purpose or general-purpose programmable processor, and may receive data and instructions from a storage system, at least one input apparatus, and at least one output apparatus, and transmit the data and the instructions to the storage system, the at least one input apparatus, and the at least one output apparatus.

Program programs for implementing the method for enhancing the PET parameter image of the present disclosure may be written in any combination of one or more programming languages. These computer programs may be provided to a processor of a general-purpose computer, a special-purpose computer, or other programmable data processing apparatuses such that the computer programs, when executed by the processor, cause functions/operations set forth in the flowchart and/or the block diagram to be performed. The program programs may be executed completely on a machine, partially on the machine, partially on the machine and partially on a remote machine as a separate software package, or completely on the remote machine or server.

### Embodiment 5

Embodiment 5 of the present disclosure further provides a computer readable storage medium, storing a computer instruction, and the computer instruction is used to cause a processor to execute a method for enhancing a PET parameter image. The method includes:
determining an original PET parameter image based on an obtained dynamic PET image set, and obtaining an input image corresponding to the original PET parameter image based on a preset mapping list;
inputting the input image into an image enhancement model to obtain an output predicted PET parameter image; and
adjusting a model parameter of the image enhancement model based on the original PET parameter image and the predicted PET parameter image until a preset number of iterations is met, and using the predicted PET parameter image as a target PET parameter image corresponding to the original PET parameter image;
wherein the input image is a noise image, a dynamic PET image corresponding to a preset acquisition time range in the dynamic PET image set or a dynamic SUV image corresponding to the dynamic PET image.

In the context of the present disclosure, the computer readable storage medium may be a tangible medium that may contain or store a computer program for use by or in combination with an instruction execution system, apparatus or device. The computer readable storage medium may include but is not limited to an electronic, magnetic, optical, electromagnetic, infrared, or semiconductor system, apparatus or device, or any suitable combination of the above contents. Alternatively, the computer readable storage medium may be a machine readable signal medium. More specific examples of the machine readable storage medium will include electrical connections based on one or more lines, a portable computer disk, a hard disk, a random access memory (RAM), a read only memory (ROM), an erasable programmable read only memory (EPROM or flash memory), an optical fiber, a portable compact disk read only memory (CD-ROM), an optical storage device, a magnetic storage device, or any suitable combination of the above contents.

In order to provide interactions with users, the systems and technologies described herein may be implemented on an electronic device, and the electronic device has: a display apparatus for displaying information to the users (e.g., a CRT (cathode ray tube) or LCD (liquid crystal display) monitor); and a keyboard and a pointing apparatus (e.g., a mouse or trackball), through which the users may provide an input to the electronic device. Other types of apparatuses may further be used to provide interactions with the users; for example, feedbacks provided to the users may be any form of sensory feedback (e.g., visual feedbacks, auditory feedbacks, or tactile feedbacks); and an input from the users may be received in any form (including acoustic inputs, voice inputs or tactile inputs).

The systems and technologies described herein may be implemented in a computing system including background components (e.g., as a data server), or a computing system including middleware components (e.g., an application server) or a computing system including front-end components (e.g., a user computer with a graphical user interface or a web browser through which a user may interact with the implementations of the systems and technologies described herein), or a computing system including any combination of such background components, middleware components, or front-end components. The components of the system may be interconnected by digital data communication (e.g., a communication network) in any form or medium. Examples of the communication network include: a local area network (LAN), a wide area network (WAN), a blockchain network and the Internet.

A computing system may include a client and a server. The client and the server are generally far away from each other and usually interact through a communication network. The relationship between the client and the server is generated by computer programs running on corresponding computers and having a client-server relationship with each other. The server may be a cloud server, also known as a cloud computing server or cloud host, which is a host product in a cloud computing service system to solve the defects of large management difficulty and weak business expansibility existing in traditional physical host and VPS services.

It should be understood that the various forms of processes shown above may be used to reorder, add, or delete steps. For example, the steps recorded in the present disclosure may be executed in parallel, or sequentially or in different orders, as long as the desired results of the technical solution of the present disclosure can be implemented, which is not limited herein.

The above implementations do not constitute a limitation on the scope of protection of the present disclosure. It should be appreciated by those of skill in the art that various modifications, combinations, subcombinations, and substitutions may be made according to design requirements and other factors. Any modification, equivalent replacement, improvement, etc. made within the spirit and principle of the present disclosure should be included in the scope of protection of the present disclosure.

What is claimed is:

1. A method for enhancing a PET parameter image, comprising:
determining an original PET parameter image based on an obtained dynamic PET image set, and obtaining an input image corresponding to the original PET parameter image based on a preset mapping list;
inputting the input image into an image enhancement model to obtain an output predicted PET parameter image; and
adjusting a model parameter of the image enhancement model based on the original PET parameter image and the predicted PET parameter image until a preset number of iterations is met, and using the predicted PET parameter image as a target PET parameter image corresponding to the original PET parameter image;
wherein the input image is a noise image, a dynamic PET image corresponding to a preset acquisition time range in the dynamic PET image set or a dynamic SUV image corresponding to the dynamic PET image.

2. The method according to claim 1, wherein when the original PET parameter image is a K₁ parameter image, a minimum acquisition time corresponding to the preset acquisition time range is 0, or, a maximum acquisition time corresponding to the preset acquisition time range is a total acquisition duration corresponding to the dynamic PET image set.

3. The method according to claim 2, before adjusting the model parameter of the image enhancement model based on the original PET parameter image and the predicted PET parameter image, further comprising:
normalizing the input image to obtain a normalized input image in a case that the input image is the dynamic PET image or the dynamic SUV image; and
registering the normalized input image with the original PET parameter image to obtain a registered input image.

4. The method according to claim 1, wherein a model architecture of the image enhancement model is a U-NET architecture, wherein the U-NET architecture comprises an encoder and a decoder, and accordingly, the inputting the input image into an image enhancement model to obtain an output predicted PET parameter image comprises:
inputting the input image into the encoder in the image enhancement model;
outputting at least two parameter feature maps based on the inputted input image by at least two encoding convolutional networks in the encoder; and
outputting the predicted PET parameter image based on the at least two parameter feature maps output by the encoder by at least two decoding convolutional networks in the decoder.

5. The method according to claim 4, wherein a convolutional layer is set between every two adjacent encoding convolutional networks in the encoder.

6. The method according to claim 4, wherein a bilinear interpolation layer is set between every two adjacent decoding convolutional networks in the decoder.

7. The method according to claim 1, wherein the adjusting a model parameter of the image enhancement model based on the original PET parameter image and the predicted PET parameter image comprises:
determining a Euclidean distance difference between the original PET parameter image and the predicted PET parameter image based on an L2 loss function; and
adjusting the model parameter of the image enhancement model by minimizing the Euclidean distance difference adopting an L-BFGS iterative algorithm.

8. An apparatus for enhancing a PET parameter image, comprising:
an input image obtaining module, configured to determine an original PET parameter image based on an obtained dynamic PET image set, and obtain an input image corresponding to the original PET parameter image based on a preset mapping list;
a predicted PET parameter image determining module, configured to input the input image into an image enhancement model to obtain an output predicted PET parameter image; and
a target PET parameter image determining module, configured to adjust a model parameter of the image enhancement model based on the original PET parameter image and the predicted PET parameter image until a preset number of iterations is met, and use the predicted PET parameter image as a target PET parameter image corresponding to the original PET parameter image;
wherein the input image is a noise image, a dynamic PET image corresponding to a preset acquisition time range in the dynamic PET image set or a dynamic SUV image corresponding to the dynamic PET image.

9. An electronic device, comprising:
at least one processor; and
a memory in communication connection with the at least one processor, wherein
the memory stores a computer program capable of being executed by the at least one processor, and the computer program is executed by the at least one processor to cause the at least one processor to be capable of executing the method for enhancing the PET parameter image according to claim 1.

10. A computer readable storage medium, storing a computer instruction, wherein the computer instruction is, when executed, used to cause a processor to implement the method for enhancing the PET parameter image according to claim 1.
